(19) United States
(12) Patent Application Publication
(10) Pub. No.: US 2014/0019990 A1
(43) Pub. Date: Jan. 16, 2014

(54) INTEGRATED CIRCUIT DEVICE AND METHOD FOR ENABLING CROSS-CONTEXT ACCESS

(71) Applicants: Doron Schupper, Rehovot (IL); Itzhak Barak, Kadima (IL); Uri Dayan, Hertzelia (IL); Noam Eshel-Goldman, Tel Aviv (IL); Lev Vaskevich, Rehovot (IL)

(72) Inventors: Doron Schupper, Rehovot (IL); Itzhak Barak, Kadima (IL); Uri Dayan, Hertzelia (IL); Noam Eshel-Goldman, Tel Aviv (IL); Lev Vaskevich, Rehovot (IL)

(73) Assignee: Freescale Semiconductor, Inc., Austin, TX (US)

(21) Appl. No.: 14/006,022

(22) PCT Filed: Mar. 30, 2011
(86) PCT No.: PCT/IB2011/051371

§ 371 Date: Sep. 18, 2013

(51) Int. Cl. G06F 9/46

(52) U.S. Cl. CPC G06F 9/461
USPC 718/108

(57) ABSTRACT

An integrated circuit device comprising an instruction processing module for performing operations on data in accordance with received instructions. The instruction processing module comprises a context selector unit arranged to selectively provide access to at least one process attribute(s) within a plurality of process contexts in accordance with at least one context selector value received thereby. The instruction processing module is arranged to receive an instruction comprising a context indication for a process attribute with which an operation is to be performed, provide the context selector value based at least partly on the context indication to the context selector unit, and execute the operation to be performed with the process attribute for at least one process context to which the context selector unit provides access in accordance with the context selector value.

### FIELD OF THE INVENTION

The field of this invention relates to an integrated circuit device and a method for enabling cross-context access within an instruction processing module.

### BACKGROUND OF THE INVENTION

In computing, multi-tasking is a technique whereby multiple processes, also known as tasks, share common processing resources such as, by way of example, a CPU (Central Processing Unit). Multi-tasking enables multiple processes to be executed seemingly simultaneously on a single CPU by switching between the different processes. The act of reassigning a CPU from one process to another is called a ‘context switch’, and is typically performed by a supervisor service, such as an operating system. Typically, a process running within a computer system consists of an image of executable machine code associated with a program; a region of virtual memory containing the executable machine code, process specific data, etc.; an operating system descriptors of resources allocated to the process; security attributes, such as the process owner and the process' set of permissions; and a processor's state (context), such as the content of registers, physical memory addressing, etc.

A context switch typically comprises switching the state of a processor (e.g. CPU) from executing within the context of one process (current context) to executing within the context of another process (next context). For example, FIG. 1 illustrates a simplified block diagram of an example of a conventional context switch procedure 100. A current process (User task N) 110 being executed comprises a context 115 within which a processor (not shown) is operating. Upon a context switch being initiated at 120, a supervisor service 130, such as an operating system, comprising its own context supervisor 135 ‘traps’ the context 115 of the current process 110 and saves it. The supervisor service 130 then ‘spawns’, for example restores or creates, a context 145 for a next process (User task P) 140. Once the subsequent context 145 for the next process 140 has been spawned, the supervisor service 130 initiates the execution of the next process 140, as illustrated at 125 Such context switches are generally computationally intensive.

To facilitate such context switches, modern CPU architectures typically support more than a single processing context by dedicating different sets of physical registers and different memory segments for each context, thereby keeping each context self contained and enforcing protection policies. For the most part, processes (and thereby their contexts) are kept separated in order to prevent one process interfering with another and causing system failures, etc. However, in some scenarios it is necessary for one process to be able to access data within the context of another process. For example, a supervisor or hypervisor process may be required to access the context of a user task for maintenance (e.g. saving a pre-empted process context, preparing to dispatch a new process, cleaning up traces of finished processes, etc.). In addition, a debugger process may require access to data within the context of a process that is being debugged, especially when debugging code running under multitasking operating systems, or when debugging the operating system code itself.

Conventionally, enabling one process to access the context of another process is associated with performance impeding configuration changes within the CPU, or complex code workaround sequences. In either case, conventional techniques for enabling such cross-context access are typically detrimental on performance and/or inhibitingly complex.

### SUMMARY OF THE INVENTION

The present invention provides an integrated circuit device and a method for enabling cross-context access as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of a conventional context switch procedure.

FIG. 2 illustrates a simplified example block diagram of an integrated circuit device.

FIG. 3 illustrates a simplified block diagram of an example of register files within an instruction processing module.

FIG. 4 illustrates a simplified block diagram of an example of a multiplexing module within a context selector unit.

FIGS. 5 and 6 illustrate examples of instructions executable by an instruction processing module.

FIG. 7 illustrates a simplified flowchart of an example of a method for enabling cross-context access.

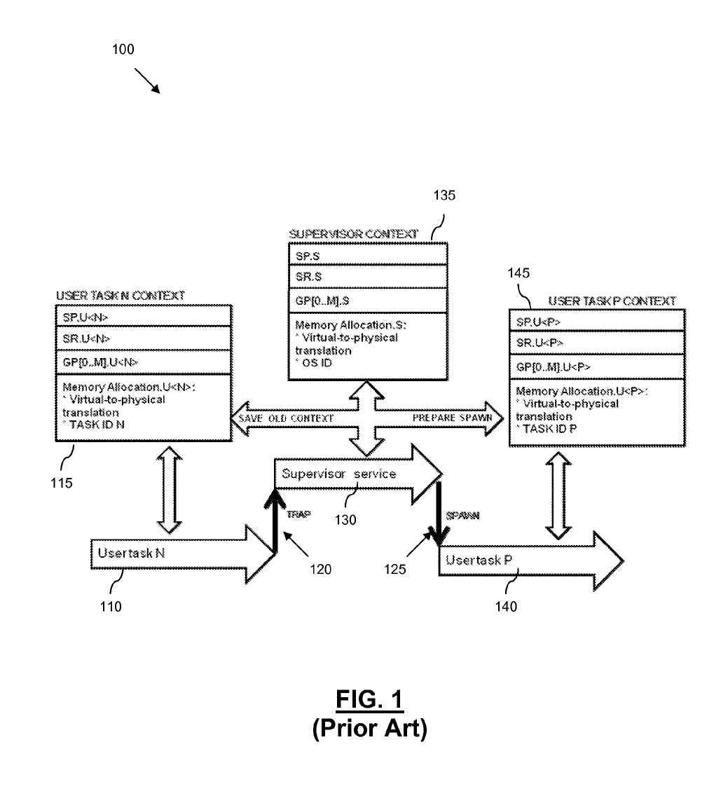

### DETAILED DESCRIPTION

Examples of the present invention will now be described with reference to an example of an instruction processing architecture, such as a central processing unit (CPU) architecture. However, it will be appreciated that the present invention is not limited to the specific instruction processing architecture herein described with reference to the accompanying drawings, and may equally be applied to alternative architectures. For example, for the illustrated examples, the instruction processing architecture comprises multiple data execution units. It will be appreciated that examples of the present invention may be implemented within an instruction processing architecture comprising any number of (e.g. one or more) data execution units. Additionally, because the illustrated example embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

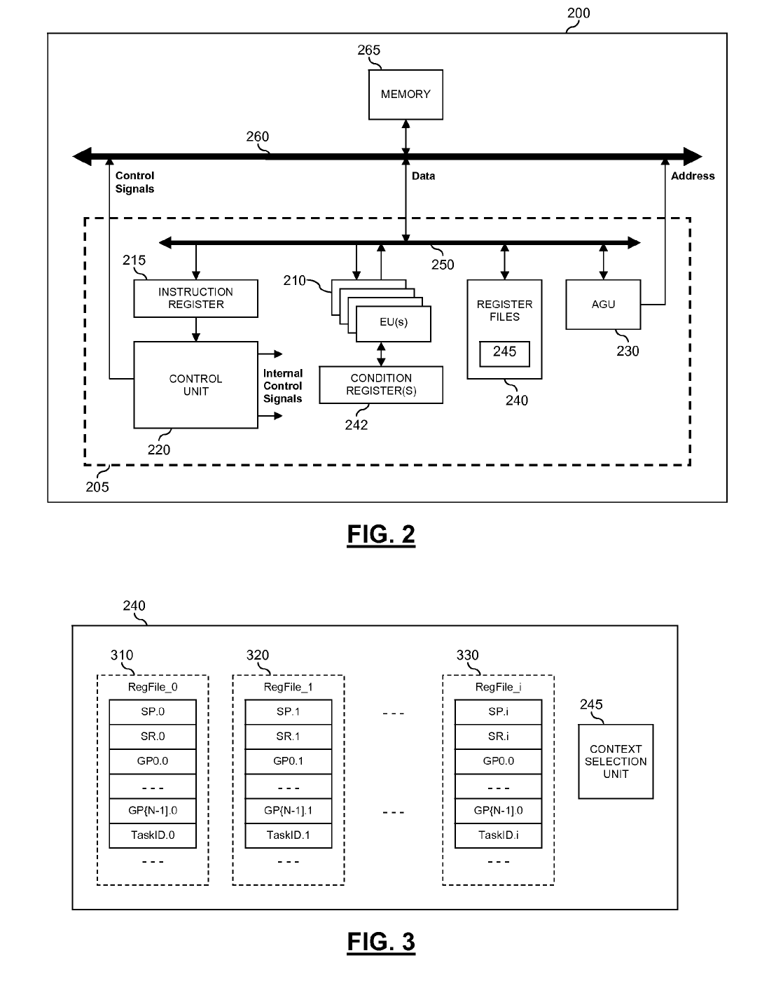

Referring now to FIG. 2, there is illustrated a simplified example block diagram of an integrated circuit device 200 comprising an example of an instruction processing module 205. For the illustrated example, the instruction processing module 205 comprises: an instruction register 215 for storing an instruction being executed or decoded; a control unit 220 for generating internal and external control signals in accordance with the current instruction being executed; one or more execution units (EUs) 210 for performing operations on data in accordance with internal control signals that are generated by the control unit 220; one or more register files 240 comprising registers for storing data, addresses, etc.; one or more condition registers 242 that typically consist of single-bit flags for indicating conditional results; and one or more address generation units 230 arranged to generate address values for accessing system memory 265. The instruction processing module 205 further comprises an internal bus 250 interconnecting the various components thereof, and thereby enabling the transmission of information and data there between. The internal bus 250, and for the illustrated example the control unit 220 and address generation unit 230, are operably coupled to an external bus 260 enabling communication with external devices such as the system memory 265, etc.

Typically, a process running within a computer system such as the instruction processing module 205 of FIG. 2 consists of attributes such as an image of executable machine code associated with a program; a region of virtual memory containing the executable machine code, process specific data, etc.; operating system descriptors of resources allocated to the process; security attributes, such as the process owner and the process' set of permissions; and a processor's state (context), such as the content of registers, physical memory addressing, etc.

Multi-tasking is a known technique whereby multiple processes, also known as tasks, share common processing resources such as, by way of example, an instruction processing module (e.g. a CPU). Multitasking enables multiple processes to be executed seemingly simultaneously on a single instruction processing module by switching between the different processes. The act of reassigning an instruction processing module from one process to another is called a context switch, and is typically performed by a supervisor service such as an operating system. To facilitate such context switches, modern instruction processing architectures typically support more than a single processing context by dedicating different sets of physical registers and different memory segments for each context, thus keeping each context self contained and enforcing protection policies.

FIG. 3 illustrates a simplified block diagram of an example of the register files 240 within the instruction processing module 205 of FIG. 2. For the illustrated example, the instruction processing module 205 comprises ‘i+1’ register files, being allocated one for each of a plurality of retained process contexts 310, 320, 330. Typically, for each process context 310, 320, 330 retained within the instruction processing module 205, the corresponding register file comprises a set of physical registers dedicated to a single process context 310, 320, 330. For the most part, processes (and thereby their contexts) are kept separated in order to prevent one process interfering with another and causing system failures, etc. However, in some scenarios it is necessary for one process to be able to access data within the context of another process. For example, a supervisor or hypervisor process may be required to access the context of a user task for maintenance (e.g. saving a pre-empted process context, preparing to dispatch a new process, cleaning up traces of finished processes, etc.). In addition, a debugger process may require access to data within the context of a process being debugged, especially when debugging code running under multi-tasking operating systems, or when debugging the operating system code itself.

In order to enable such cross-context access, and additionally referring back to FIG. 2, the instruction processing module 205 comprises at least one context selector unit 245 arranged to selectively provide access to process attributes within a plurality of process contexts in accordance with at least one context selector value received thereby. Furthermore, the instruction processing module 205 is arranged to receive, for example within the instruction register 215, instructions comprising one or more context indications for one or more process attributes with which at least one operation is to be performed. The instruction processing module 205 is further arranged to provide, for example by way of the control unit 220, one or more context selector values based at least partly on the context indication(s) to the context selector unit(s) 245, and execute, for example by way of one or more of the execution units 210, the operation(s) to be performed with the process attribute(s) for at least one process context to which the context selector unit(s) 245 provides access in accordance with the context selector value(s).

In this manner, a simple and efficient mechanism for enabling cross-context access is provided whereby the need for performance impeding configuration changes and/or complex code work-around sequences is substantially alleviated. Such a context selector unit 245 may be arranged to selectively provide access to substantially any process attribute(s) that uniquely, or discernibly, correspond to one or more process contexts. For example, the context selector unit 245 may be arranged to selectively provide access across a plurality of contexts, to one or more from a group of:
(i) a stack pointer;
(ii) a status register;
(iii) at least one general purpose register;
(iv) a process identifier;
(v) virtual-to-physical address mapping.

The present invention is not intended to be limited to the attributes listed above, which are only provided as examples.

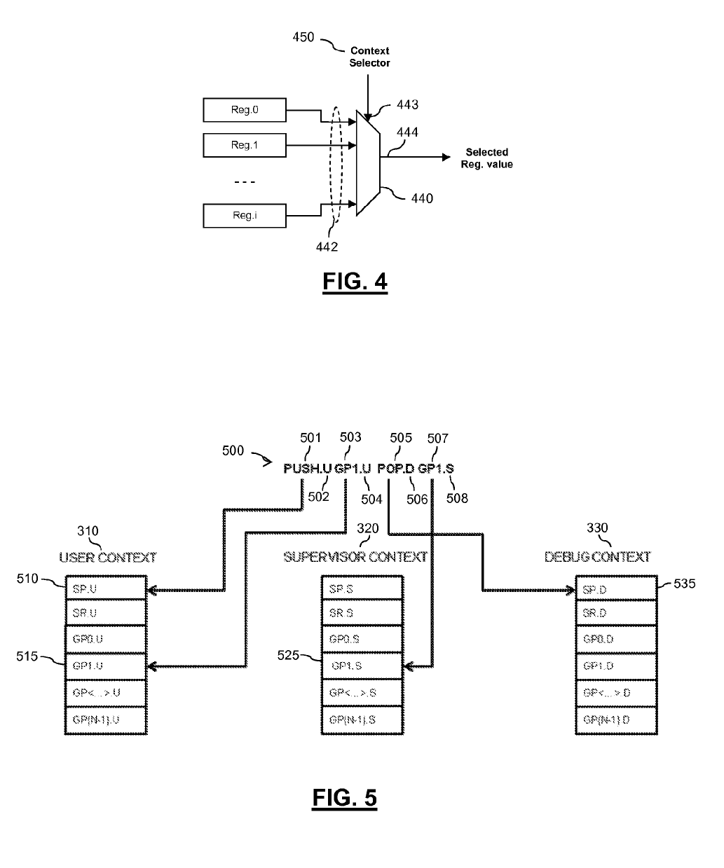

In accordance with some examples, the context selector unit 245 may comprise one or more multiplexing modules, for example such as the multiplexing module 440 illustrated in FIG. 4. The (or each) multiplexing module 440 may comprise a first set of inputs, illustrated generally at 442, arranged to receive a process attribute for each of a plurality of process contexts, such as the process contexts 310, 320, 330 illustrated in FIG. 3. The (or each) multiplexing module 440 may further comprise a second set of inputs, illustrated generally at 443, arranged to receive at least one context selector value 450 for the process attribute, and may be arranged to provide at an output 444 thereof access to the process attribute for one of the process contexts in accordance with the received context selector value 450. In this manner, the multiplexing module 440 is able to provide access to, for example, a particular process attribute stored within, say, a physical register within the register file of each context 310, 320, 330 of FIG. 3. Specifically, the multiplexing module 440 is able to selectively provide access to the respective process attribute within a particular context in accordance with the received context selector value 450. Thus, by providing a context selector value based at least partly on a context indication within a received instruction to the multiplexing module 440, cross-context access may be achieved for the respective process attribute.

The context selector unit 245 may comprise a multiplexing module, such as the multiplexing module 440 illustrated in FIG. 4, for each of one or more sets of process attributes. For example, such a set of process attributes may comprise a single process attribute, whereby cross-context access may be provided to attributes individually. Alternatively, two or more process attributes may be grouped into a set of attributes, whereby cross-context access may be provided to the set of attributes as a whole.

For example, FIG. 5 illustrates an example of an instruction 500 for, say, execution by the instruction processing module 205 of FIG. 2. For the illustrated example, the instruction 500 comprises two operation codes (opcodes), and is executed within a process comprising a first user context, say user context 310 of FIG. 3. To help clarify the example instruction 500, the operation of FIG. 5 will be described with reference to specific examples of the three contexts 310, 320, 330 of FIG. 3. The first opcode 501 requires a PUSH operation to be performed, whereby the content of a specified register is stored (or ‘pushed’) to a process stack. The first (PUSH) opcode 501 comprises a context indication 502 corresponding to the ‘User Context’ 310, for example the current context, and is followed by an operand 503 specifying a general purpose register ‘GP1’, the content of which is to be stored to the stack. The operand 503 also comprises a context indication 504, which for the illustrated example also corresponds to the ‘User Context’ 310.

Accordingly, this part of the received instruction 500, when executed within the instruction processing module 205, requires access to the stack pointer and general purpose register GP1 within the ‘current’ (User) context 310, illustrated at 510 and 515 respectively. As such the instruction processing module 205 provides a context selector value based on the context indications 502, 504 for the current (User) context 310 within the instruction 500 to the context selector unit 245 in relation to the stack pointer and general purpose register GP1 attributes. The context selector unit 245 may then provide access to the stack pointer 510 and general purpose register GP1 515 within the current (User) context 310 for the PUSH operation to be performed by, say, an execution unit 210. For the execution of this first (PUSH) opcode 501 within the instruction 500, the context indications 502, 504 correspond to the current (User) context 310 for the ‘active’ process that is being executed. As such, no cross-context access is required.

The second opcode 505 requires a POP operation to be performed, whereby content from a stack is loaded (or ‘popped’) into a specified register. The second (POP) opcode 505 comprises a context indication 506 corresponding to a ‘Debug Context’ 330, i.e. a further context for a different process to the active process, and is followed by an operand 507 specifying a general purpose register ‘GP1’ from which content is loaded. The operand 507 also comprises a context indication 508, which for the illustrated example corresponds to a ‘Supervisor Context’ 320, i.e. a still further context for a still further, supervisor process such as within an operating system.

Accordingly, this part of the received instruction 500, when executed within the instruction processing module 205, requires access to the stack point attribute 530 within the Debug Context 330, and to the general purpose register GP1 525 within the Supervisor context 320. As such the instruction processing module provides a context selector value based on the context indication 506 for the Debug context 330 within the instruction 500 to the context selector 245 in relation to the stack pointer attribute, whilst providing a context selector value base on the context indication 508 for the Supervisor context 320 within the instruction 500 to the context selector 245 in relation to the general purpose register GP1 attribute. The context selector unit 245 may then provide access to the stack pointer 530 and general purpose register GP1 525 within the Debug and Supervisor contexts 330, 320 respectively for the POP operation to be performed by, say, an execution unit 210 of FIG. 2.

Thus, dynamic cross-context access to process attributes may be achieved in a simple and effective manner, by information that is encoded within the instruction 500. For the example illustrated in FIG. 5, and described above, such information is encoded within the instruction 500 by way of context indications for operands within the instruction, and in particular for the illustrated example per-operand context indications, whereby different contexts may be accessed on a per operand basis. Such context indications need not be limited to being provided on a per operand basis, but may comprise any suitable scope. For example, context indications may be utilised on a per instruction basis (i.e. corresponding to all operands within the instruction). Furthermore, such context indications may be provided throughout an instruction set architecture for, say, the instruction processing module 205. Alternatively, such context indications may be limited to only a subset of defined instructions within the instruction set architecture for, say, the instruction processing module 205. Significantly, full cross-context access to all attributes within each context may be achievable, thereby enabling efficient cross-context access, reducing cross-context save operations and restoring latency during context switches. This may substantially alleviate the need for complex cross-context access code workaround sequences.

In order to prevent one process interfering with another, and thereby causing system failures, etc., a process is typically restricted to accessing its own allocated memory space. Accordingly, in order to enable cross-context memory accessing, it is often necessary to ‘mask’ such an access in order to give the impression that the access is being performed by the appropriate process. As such, upon receipt within a first, active, process of an instruction requiring accessing system memory, such as system memory 265 of FIG. 2, and comprising a context indication therefor relating to a context of a further process, the instruction processing module 205 may be arranged to provide a context selector value based at least partly on the context indication within the received instruction. The instruction processing module 205 may be to the context selector unit 245 such that the context selector unit 245 selectively provides access to a process identification attribute within the context of the further process. The instruction processing module 205 may then initiate a cross-context system memory access using the process identification attribute of the further (i.e. non-active) process.

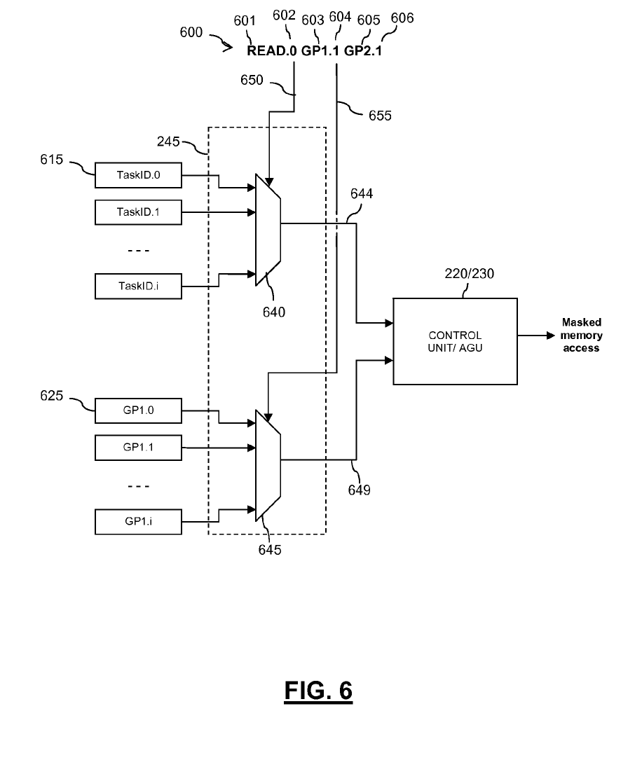

FIG. 6 illustrates a simplified example of performing such a cross-context memory access according to some examples. A memory access instruction 600, which for the illustrated example is a ‘read’ instruction within a first, active process ‘1’, contains a READ opcode 601, which comprises a context indication 602 corresponding to a second, inactive process ‘0’. The READ opcode 601 is followed by two operands 603, 605. The first operand 603 identifies a first register (GP1) containing an address in memory to be accessed, and comprises a context indication 604 corresponding to the first, active process ‘1’. The second operand 605 identifies a second register (GP2) into which the content of the address in memory is to be read into (i.e. stored). Upon receipt of such an instruction 600, the instruction processing module 205 of FIG. 2 provides a context selector value 650 based on the context indication 602 for the opcode 601. The instruction processing module 205 provides the context selector value 650 to the context selector unit 245 of FIG. 2, such that the context selector unit 245 selectively provides access to a process identification attribute within the context of the process identified by the context indication 602.

For the illustrated example, the context selector unit 245 comprises a first multiplexing module 640, which provides access to process identification attributes stored within, say, physical registers within the register files of process contexts. Thus, upon receipt of the context selector value 650, the multiplexing module 640 selectively provides access to (for example outputs 644) the process identification attribute 615 for the second, inactive process ‘0’. In addition, the instruction processing module 205 provides a further context selector value 655 based on the context indication 604 for the operand 603. The instruction processing module 205 provides the context selector value 655 to the context selector unit 245, such that the context selector unit 245 selectively provides access to a general purpose register attribute corresponding to the operand 603 within the context of the process identified by the context indication 604.

For the illustrated example, the context selector unit 245 comprises a second multiplexing module 645, which provides access to general purpose first register (GP1) attributes within the register files of process contexts. Thus, upon receipt of the context selector value 655, the second multiplexing module 645 selectively provides access to (for example outputs 649) the general purpose first register (GP1) attribute 625 for the first, active process ‘1’. In this manner, a read operation may subsequently be performed, for example by the control unit/address generation unit (AGU) 220/230 of the instruction processing module 205, whereby a cross-context memory access is achieved using the process identification attribute 644 and the address on the outputs 649 provided by context selector unit 245.

Although not illustrated in FIG. 6, the instruction processing module 205 may in some examples provide a further context selector value (not shown) based on the context indication 606 for the operand 605 to the context selector unit 245, such that the context selector unit 245 selectively provides access to a general purpose second register attribute corresponding to the operand 605 within the context of the process identified by the context indication 606, in order to store the retrieved memory content.

The types of processes that typically require such cross-context access include, by way of example only, operating system code maintenance processes (for example saving pre-empted process contexts, preparing to dispatch a new process, cleaning up traces of finished processes, etc.), debugger core processes (especially when debugging code running under multi-tasking operating systems, or when debugging the operating system itself), hypervisor processes, etc. Thus, typically such cross-context access is required by privileged users/trusted code. Such privileged users/trusted code is typically allowed full access to all machine resource (or can obtain these rights by simple code sequences). It is envisaged that simple user processes, in contrast, may not be permitted to perform instructions that allow cross-context access. It is further envisaged that ‘middle-privileged’ processes (for example supervisor vs. hypervisor) may be allowed to access a limited cross-context access, for example allowing access to less privileged process contexts, but not allowing access to higher privileged process contexts.

In some examples, the configuration based mapping of physical registers to virtual registers may be used to minimize encoding space impact. For example, for four process contexts, and thus four stack pointer registers, an “other stack pointer” configuration field may be defined by selecting a single physical stack pointer. Instructions accessing the “other stack pointer” may then be defined along with instructions accessing a “current stack pointer”.

Instruction sets are typically defined by the number of bits that a single opcode occupies, e.g. a 32-bit instruction set comprises 32 bit opcodes. In such a 32-bit example there is a 32-bit budget on the information that an op-code may contain. Incorporating context indications for one or more process attributes into the typically already tight bit budget of an instruction set may be difficult. In order to overcome tight bit budgets within instruction sets, in some examples additional ‘non-op-code’ words may be added to instructions, for example the additional ‘non-op-code words’ holding all means of information that may be relevant to the different op-codes in the instruction. These extra words are sometimes called suffix or prefix words. Accordingly, in some example embodiments, context indications for one or more process attributes may be provided within such a non-op-code word added to an instruction, and need not directly be a part of the corresponding op-code word.

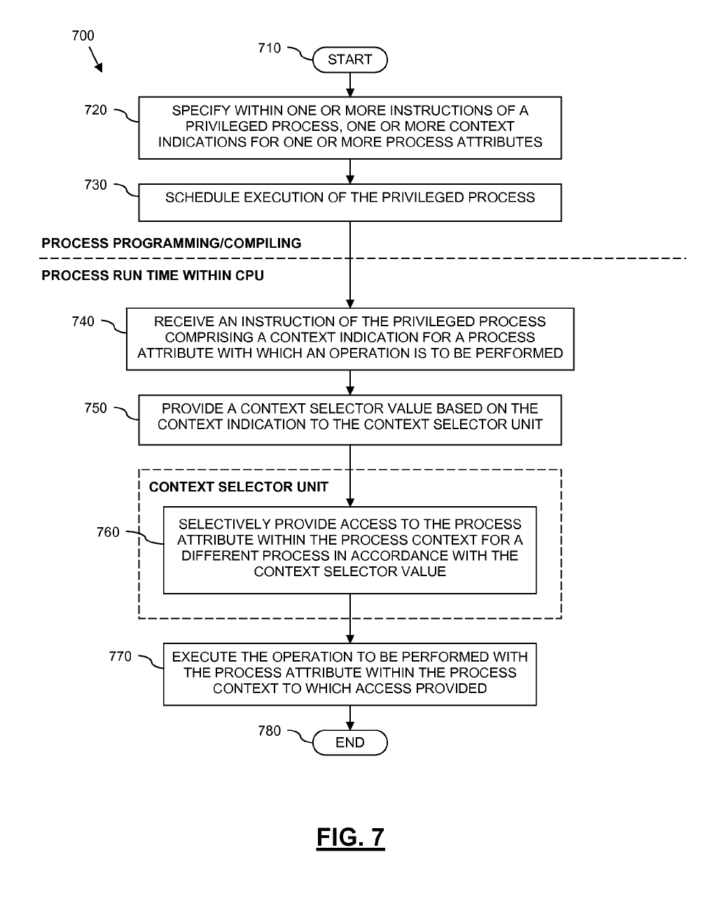

Referring now to FIG. 7, there is illustrated a simplified flowchart 700 of an example of a method for enabling cross-context access within an instruction processing module, such as the instruction processing module 205 of FIG. 2. The method starts at 710, for example during programming and compiling etc. of computer program code for, in this example, a privileged process (e.g. a supervisor/hypervisor/debug process). The method moves on to 720 where one or more context indication(s) for one or more process attribute(s) is/are specified within one or more instructions of the privileged process. The privileged process is then scheduled for execution by the instruction process module at 730. Subsequently, during run time for the process(es) within the instruction processing module, one or more instruction(s) of the ‘active’ process is/are received that comprise, for example, one or more context indication(s) for at least one process attribute with which an operation is to be performed, at 740.

For the illustrated example, one or more context selector value(s) based at least partly on the context indication(s) within the received instruction is/are provided to a context selector unit, at 750, which then selectively provides access to the corresponding process attribute(s) within the process context(s) of one or more different (i.e. non-active) process(es) in accordance with the received context selector value(s), at 760. The operation(s) to be performed with the process attribute(s) is/are then executed at 770. The method then ends at 780.

Thus, a method and apparatus have been described that enable simple and efficient cross-context accessing within an instruction processing module, such as a CPU or the like. Such improvements in cross-context access may enable operating system context switching saves and may reduce latency, which is of particular significance in real-time applications. Furthermore, such improvements in cross-context accessing may enable debugger code to be simplified, thereby allowing complete and simple access to the various contexts under debug.

Parts of the invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the context selector unit 245 has been illustrated as being implemented within the register files 240. However, it will be appreciated that the context selector unit 245 may equally be implemented as a separate functional unit, or as part of one or more other components within the instruction processing module 205, for example the AGU control unit 220.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising at least one instruction processing module for performing operations on data in accordance with received instructions thereby, the at least one instruction processing module comprises at least one context selector unit arranged to selectively provide access to at least one process attribute(s) within a plurality of process contexts in accordance with at least one context selector value received thereby;
wherein the at least one instruction processing module is arranged to:
receive at least one instruction comprising at least one context indication for at least one process attribute with which at least one operation is to be performed;
provide at least one context selector value based at least partly on the at least one context indication to the at least one context selector unit; and
execute the at least one operation to be performed with the at least one process attribute for at least one process context to which the context selector unit provides access in accordance with the at least one context selector value.

2. The integrated circuit device of claim 1 wherein the at least one context selector unit is arranged to selectively provide access to the at least one process attribute(s) within the plurality of process contexts comprising at least one from a group consisting of:
(i) a stack pointer;
(ii) a status register;
(iii) at least one general purpose register;
(iv) a process identifier; and
(v) virtual-to-physical address mapping.

3. The integrated circuit device of claim 1 wherein the at least one instruction processing module is arranged to receive within a first, active, process an instruction that requires accessing the at least one process attribute, and wherein the instruction comprises at least one context indication therefor relating to a context of at least one further process.

4. The integrated circuit device of claim 3 wherein the at least one instruction processing module is arranged to provide at least one context selector value, based at least partly on the at least one context indication, to the context selector unit).

5. The integrated circuit device of claim 3 wherein the context selector unit selectively provides access to the at least one process attribute to be accessed within the context of the at least one further process.

6. The integrated circuit device of claim 3 wherein the at least one instruction processing module is further arranged to access the at least one process attribute(s) within the context of the at least one further process.

7. The integrated circuit device of claim 1 wherein the at least one instruction processing module is arranged to receive within a first, active, process an instruction that requires accessing system memory, wherein the instruction comprises at least one context indication therefor relating to a context of at least one further process.

8. The integrated circuit device of claim 7 wherein the at least one instruction processing module is arranged to provide at least one context selector value based at least partly on the at least one context indication to the context selector unit.

9. The integrated circuit device of claim 8 wherein the context selector unit selectively provides access to at least one process identification attribute within the context of the at least one further process.

10. The integrated circuit device of claim 7 wherein the at least one instruction processing module is arranged to initiate a system memory access using the at least one process identification attribute of the at least one further process.

11. The integrated circuit device of claim 1 wherein the context selector unit comprises at least a first multiplexing module comprising
a first set of inputs arranged to receive a first process attribute for each of a plurality of process contexts; and
a second set of inputs arranged to receive at least one context selector value for the first process attribute,
the first multiplexing module being arranged to provide at an output thereof access to the first process attribute for one of the process contexts in accordance with a received context selector value.

12. The integrated circuit device of claim 11 wherein the context selector unit comprises at least one further multiplexing module arranged to provide at an output thereof access to at least one further process attribute for one of the process contexts in accordance with a received context selector value.

13. A method for enabling cross-context access within an instruction processing module, the method comprising:
receiving at least one instruction comprising at least one context indication for at least one process attribute with which at least one operation is to be performed;
selectively enabling access to the at least one process attribute within a process in accordance with the at least one context indication; and
executing the at least one operation to be performed with the at least one process attribute for at least one process context to which the context selector unit provides access in accordance with the at least one context selector value.

14. The method of claim 13 where the method comprises:
receiving within a first, active, process an instruction requiring accessing at least one process attribute, and comprising at least one context indication therefor relating to a context of at least one further process;
selectively enabling access to the at least one process attribute to be accessed within the context of the at least one further process; and
accessing the process attribute within the context of the at least one further process.

15. The method of claim 13 where the method comprises:
receiving within a first, active, process an instruction requiring accessing system memory, and comprising at least one context indication therefor relating to a context of at least one further process;
selectively enabling access to at least one process identification attribute within the context of the at least one further process; and
initiating a system memory access using the at least one process identification attribute of the at least one further process.
